(19) United States
(12) Patent Application Publication
(10) Pub. No.: US 2009/0177397 A1
(43) Pub. Date: Jul. 9, 2009

(54) Method And Apparatus For Distribution Of Positional Information

(76) Inventor: Michael Routtenberg, Surrey (CA)

Correspondence Address: MCANDREWS HELD & MALLOY, LTD, 500 WEST MADISON STREET, SUITE 3400, CHICAGO, IL, 60661, US

(21) Appl. No.: 12/019,836

(22) Filed: Jan. 25, 2008

Related U.S. Application Data
(60) Provisional application No. 61/019,595, filed on Jan. 7, 2008.

(51) Int. Cl. G01C 21/00; G01S 5/00

(52) U.S. Cl. 701/213; 705/1

(57) ABSTRACT

A method and apparatus collect and distribute geographic information for the purposes of securing marketing information such as real estate information selected by reference to geographic information. The method includes a transmission of audio information such as DTMF tones by electromagnetic signals such as Bluetooth™ from a position information acquiring device to a wireless device for communicating the request for marketing information to a server. The method and apparatus provide for an inexpensive method of commanding a wireless device to retrieve marketing information selected according to geographic position of a user seeking such information without having to modify or manipulate most commercially available wireless devices.

### CROSS-REFERENCE TO RELATED APPLICATION(S)

This application is related to and claims priority benefits from U.S. Provisional Patent Application Ser. No. 61/019,595 filed Jan. 7, 2008, entitled “Method And Apparatus For Distribution Of Positional Information”. The '595 provisional application is hereby incorporated by reference herein in its entirety.

### FIELD OF THE INVENTION

The present invention relates to a method and apparatus for communicating geographical positional information to a wireless device for the purpose of delivering marketing or other target information to a user based on positional information of the user when the request is made.

### BACKGROUND OF THE INVENTION

Geographical location information is becoming more commonly used as the cost of geographical positioning system (GPS) chipsets declines. As such, location-based services (LBS) that use positional information are becoming more feasible. LBS in general, however, have focused on services that provide geographical directions to a user or emergency services that alert authorities in the event of emergency situations. Such applications, used in conjunction with a wireless device, communicate with an operator or map file server that is used to determine the location of a distress call (Tendler U.S. Pat. No. 5,555,286; U.S. Pat. No. 6,516,198; U.S. Pat. No. 7,050,818) or to communicate directions to a user, as the case may be. Such LBS have however been generally limited to applications where geographical location information is the goal of the service. That is, the goal is to provide directions from one geographical location to another or to provide emergency assistance to a user at a particular geographical location.

Geographical location information however can be associated with marketing information relevant to a user's location. One particular use associating geographic information with marketing data has been in real estate where geographical positioning system (GPS) information is built into a wireless device that includes software capable of accessing real estate information databases. As real estate marketing information is one of the few marketing databases available with positional information as a parameter to sort this marketing information, it is not surprising that real estate has been an area of early interest for developers of applications that try to combine LBS and marketing services. As such, provides a good illustrative example of how an LBS and marketing service can be used. Other marketing data relevant to retail, tourism or other service providers require a positional database be developed before exploiting the capability of an LBS directed at these markets.

In the real estate context, a user's geographic position determined from a GPS receiver is associated with a property being marketed where the user is given access to information associated with a property proximate to the geographic position of the user (in most cases). By way of example, such systems have been disclosed in Hartz, Jr. et al. U.S. Pat. No. 6,636,803 B1; Jenkins U.S. Pat. No. 6,681,107 B2; Dowling U.S. Pat. No. 6,983,139; and Blumberg U.S. Pat. No. 6,385,541 B1.

Hartz, Jr. et al. U.S. Pat. No. 6,636,803 B1 discloses a navigational system equipped with a data terminal, GPS receiver and data enabled mobile phone which accesses a remote server and downloads property information from a Multiple Listing Service (MLS) database which is then stored in the mobile system. The device has a map generation unit which generates a digital map of the property area of interest and integrates onto the digital map available properties. The GPS is then used to guide the user to the property locations. This system requires large data storage and processing unit equipped with specialized software that integrates and then displays information from the various digital information databases onto the systems interactive display.

Jenkins et al. U.S. Pat. No. 6,681,107 B2 discloses a system and method of accessing and recording messages at certain waypoints, namely, leaving and retrieving virtual post it notes at specific geographic locations. When the user's communication device is located within the influence of the commercial mobile radio service (CMRS) provider network and comes into an area having a “virtual post it note” it will automatically receive the message if the user's preferences permit receiving that particular type of message. In one embodiment, Jenkins discloses a method for real estate inquires whereby a property owner or real estate agent posts information such as MLS type information to the physical location of the property. When a person with the interfacing device reaches the specific location of the property, he or she can learn more about the property by pushing a button on his device. Upon depressing the button on the device, the network transmits MLS type information to the device. If the user is interested in the property, the user can send that information to their agent or property leasing office by printing or electronically such as through faxes or email. When turned on and within the network area, the device continuously updates its location and checks for information that may be accessible to the user at that location. If there is no posted information at that location then the device waits for a beacon signal and then resumes updating its location. This system requires huge database management servers not only to contain the whereabouts of the continuously updating devices but also to hold the messages for each way point distributed through the network area. This system also requires the participants to be part of the provider network and it only works when the user is within the provider network with the particular enabled communication device.

Dowling U.S. Pat. No. 6,983,139 discloses a GPS enabled mobile unit which communicates wirelessly with a network server. The network server uses a set of user preferences to filter a set of server-side information in accordance with a user's interest and the user's present location. A content-selective information filter performs a network server-side search to identify content that matches the user's preferences and the user's location and selectively generates an unsolicited message at a later time to notify the user of relevant results when the user enters a geographical area where the search is satisfied. In some embodiments, the message is used to notify the user that information is available for download, and in other embodiments the message provides the content directly to the user. In one embodiment related to a real estate application, Dowling discloses a home for sale having an electronic real estate sign which broadcasts its MLS information from the home to mobile units driving by.

Blumberg U.S. Pat. No. 6,385,541 B1 discloses a system for accessing a database containing real estate information over a communications network using a handheld GPS enabled wireless communications device. Based upon the geographic position of the wireless device, the database returns information relating to a property located proximate to the geographic position of the device. When the user is proximate to the property of interest the user activates the wireless device to determine the user's geographic position. The wireless device then accesses the database and retrieves information relating to the property. The user can then access additional information relating to the property, make a bid on the property, schedule an appointment to view the property, or search for additional properties, through the wireless device. If the user requires assistance during this process, the user can use the device to contact an agent and be connected to a call center or realtor-connected office to receive additional information.

The shortcomings of many of these approaches however, is that they rely on multifaceted wireless communication devices that have device specific information management software and GPS receivers. This creates three issues. First, at present, relatively few wireless communication devices have GPS receivers. While many wireless communication devices do employ GSM localization, a possible substitute for GPS position information, the accuracy of such systems is not particularly appropriate to provide approximate positional information, frequently only accurate to a few hundred meters. This tends to be unsuitable for applications that require positional information that is accurate to within a few tens of meters, as is the case for most marketing information services including those associated with real estate information.

Second, GSM localization, in situations where it provides accurate enough positional information, is network derived from the wireless carriers' own proprietary network (using a form of signal triangulation) as opposed to being generated within the wireless device itself (as is the case with GPS), which may not be available from a network provider.

Third, such an approach requires users who are willing to incur the time, inconvenience and expense of upgrading their wireless devices to include GPS capability. Such devices also require the installation of device specific software before they could deliver marketing or informational data based on the user's positional information. In the case of GPS enabled cell phones, custom software is usually needed for each make and model of cell phone, which would require cooperation from cell phone manufacturers, complicating the implementation of such a system.

Communication directly with a database server through the public switched network or internet tend to require hardware that would act as a stripped down cell phone and would likely require its own account with a cellular carrier. The additional costs, size and weight make such an approach impractical. In a broad sense, services that combine marketing information and real time positional information of a user have been limited by the “closed” nature of the wireless devices relied upon to transmit information. Unless the LBS and wireless device are integrated together, developers have had difficulty easily accessing a wireless device from a device that secures positional information.

Moreover, in general, it is difficult to control data transfer with a wireless device over a data channel, due to proprietary restrictions imposed by the wireless device manufacturers.

Unlike the above, there have been some location based service systems developed to work in conjunction with non-enabled GPS cell phones to provide the user with positional information in order to obtain LBS. These systems involve using a separate GPS enabled locator device that communicates its position to a second communications device, namely, cell phone, personal digital assistant (PDA) or the like. One such device disclosed by Wortham in U.S. Pat. No. 7,228,139, determines the location of a mobile communications device such as a standard cell phone.

Using the wireless communications device, namely, cell phone, a user establishes a wireless communications link with a manned or unmanned service center such as a “911” or roadside assistance service center and then depresses a button on the position locator. The locator then communicates its location message via encoded audio signals, such as a dual-tone multi-frequency (DTMF), to the service center. Wortham's GPS enabled device works as a slave to the master device, namely, the cell phone. It only gives a location message to the user's cell phone after the user has first established a wireless connection to the service center using the cell phone. After depressing a button on the locator device so that it transmits the location information, the user must still identify (on the wireless device) the requested service or information desired and how that information is to be delivered. Further, the delivered information is provided over the same communications channel through which the request is made. Consequently, if a request was initiated through an audio communications channel the information could be delivered only in audio form. This would make it difficult to deliver requested information in the more preferable form of text and or images—which would require a data channel.

Wortham, in U.S. Pat. No. 7,308,272, discloses a separate mobile phone locator having GPS, signal converter, output device, an impact sensor and an activation trigger. In one embodiment the signal converter converts the GPS signal to DTMF audio tones that are then sent via a speaker to the microphone of a proximate phone. The mobile phone locator is placed on the window or dash of a car and in the event of an accident the impact sensor activates the GPS, stores the coordinates and then transmits a command to the proximate mobile phone to dial a phone number for emergency services. The locator message is then sent via DTMF audio tones to a call center, which converts the DTMF audio tones to the latitude and longitude of the mobile phone. The location message can provide additional information such as the velocity and altitude of the locator. In addition, to phone number(s) for emergency services, the phone can also dial additional numbers such as the user's home phone number. In another embodiment, instead of DTMF audio tones, Wortham discloses encoding the location message in alternate formats such as Bluetooth™ infrared beams to then be transmitted to the transceiver (data port) chip of the proximate mobile phone. Wortham does not disclose the mobile phone locator having or sending a locator ID which is in turn linked to or associated with a user profile nor an information service request, where the user obtains the requested information back to either the user's cell phone or other electronic devices.

Fan et al. U.S. Pat. No. 6,882,313 discloses a location-relevant service system having a mobile device for collecting and distributing positional information for a second mobile device, namely, a cell phone, PDA, or portable computer. This allows users of bulky, yet more sophisticated GPS enabled devices, such as those mounted in a vehicle, greater mobility by providing the user with positional information to the second mobile device either through a wired or wireless link directly to the second mobile device or through a separate wireless link to a location relevant server connected to a data network that is also accessible by the second mobile device. This system links the mobile device for collecting and distributing positional information to an individual second mobile device either through a wired connection such as a 1394 serial bus interface or through a wireless link which is not described. The wireless link that is described is the link between the second mobile device and the location relevant server in which the second mobile device uses a wireless gateway and internet gateway via wireless link and conventional data communication links or a browser adapted for a wireless communication protocol (for example, WAP) which accesses a web server where the location relevant information is stored. The location relevant information is requested and then returned real time to the second mobile device over the same wireless connection. The positional device acts as a slave to the second mobile device, giving positional information to the second mobile device when requested by either the second mobile device or by the location relevant service server.

In some prior art examples (for example, Wortham U.S. Pat. No. 7,228,139 and Wortham U.S. Pat. No. 7,308,272 B1) discussion is made of a LBS system device developed to work in conjunction with a wireless communications device, each relies on the universality of the audio link that allows users to communicate to others through their wireless devices. Here the audio links are used to transmit DTMF tones through the audio receiver. Use of the audio link however, frequently results in “contamination” of the audio signal, as background noises still persist. The two tone signals from, by way of example, a DTMF audio transmission, can be inaccurately recorded by a receiver if accompanied by background noises. While this art discloses links as “wireless” they are fundamentally different and inferior to a wireless link based on radio or infrared communications, which are not subject to the signal degradation and obtrusiveness as are audio linkages.

Moreover, much of the art discussed above ties a user's identification or profile with a particular wireless device identification. As such, whether using a position determining device that is independent of the wireless devices physically or integrated into the wireless device, the positional determination function and the information transmission function are linked, which restricts LBS applications. A user would need to have both the positional determination function and specific wireless function on hand in order to use it.

Finally, both Fan and Wortham work on the basis that the wireless device drives the system as a whole. This requires, at a minimum, the user to incorporate a multi-step approach that initiates a connection with a server with the wireless device and, once secured, initiating communication of positional information from the GPS device and then, if desired, communicating from the wireless device a sought service. The more steps between the two devices the greater likelihood for error and less likelihood of widespread adoption of a given system, which is an important limitation for developing a meaningful log of voluntarily submitted consumer activity.

Burgess U.S. Pat. No. 7,257,391 discloses a system and method for enabling a user to request and receive product information, participate in voting or polling activities, reprint an article or other publication, request and authorize a purchase of a magazine subscription, music sound clip, or other product, and/or share personal information with other users using a mobile phone. Unlike earlier art it does not require users to dial a telephone number and obtain information through a voice based conversation, or to be connected to an IVR/automated attendant phone system which can be ineffective, or remember a URL, and/or have to enter a URL into a web enabled phone. Instead, Burgess discloses a system in which a user dials a series of numbers into a phone and enters them into the system, for example by pressing the send key on a phone. The digits entered by the user include a prefix or routing code, and a data code. The dialed digits are transferred to a call switching system, which determines, based on the prefix code, a processing system to which a message is sent including the originally dialed digits as well as identification of the user or phone that placed the call. The preferred identification of the user is by way of the user's mobile phone identification number (MIN). The processing system can then determine a user account based on the identification of the mobile phone that placed the call. The processing system further determines based on the data code of the dialed digits, the product information or other service that is to be provided. The user account information can be used to determine a delivery technique, such as electronic mail using an electronic mail address associated with the phone that made the call, SMS/MMS/EMS text messaging, or WAP push, through which the product information associated with the data code can be forwarded to the requesting user. Burgess contemplates automatically collecting, processing and cataloguing consumer transaction data linked to a user's account, which is then provided to advertising and marketing agencies. However, this system is location independent and does not take advantage of a user's location to help further customize the information sought or tie the consumer activity to the geographic location of the user.

The present method and apparatus provide a technique for managing the information transmitted by the user through the locator device. This provides a way of creating adoption of a system to communicate consumer activity through one routing server that can log such information with each user's geographical position, thereby resulting in a database of such consumer activity.

The present system and method provide a technique for supplying users easy, cost effective access to marketing information relevant to a particular geographical location and marketers easy access to their customers seeking marketing information knowing that information is being sought on a voluntary basis. The present locator device can wirelessly communicate with a broad cross section of non-GPS enabled wireless devices such as a cell phone or PDA, without requiring that such devices to be outfitted with specialized software and a method of managing the information transmitted by the user through the locator device. This fosters adoption of a system to communicate consumer activity through one routing server that can log such information with each users geographical position resulting in a database of such consumer activity.

The present method and apparatus provide a technique for logging consumer behavior for a variety of different retail, tourism or other services delivered and tying that activity to positional information and a user profile associated with the activity.

For the purposes of this application, a locator device is a data collection device capable of, usually at the voluntary initiation by a user:
(a) securing positional information in real time (from a detached or integrated triangulation calculating system, or detached or integrated GPS receiver);
(b) communicating that information with a wireless communications device such as a cell phone, PDA or the like without having to customize the software or hardware available in such a wireless device;
(c) controlling the initiation and nature of an information request, independent of the wireless device.

Also, for the purposes of the application, a wireless device includes devices that act as a communications portal, which might include wired devices. For example, a computer physically connected to a communications network could communicate wirelessly with the locator device, and then relay information communicated by the locator device over the hard-wired communications network.

A locator device, as provided for above, also provides a means of isolating a user's identification from a marketing service provider creating loyalty between the device provider and the service provider.

### SUMMARY OF THE INVENTION

The present method and apparatus provide a locator device which acts as the master device, using one or more mobile communications devices; namely, cellular phone, PDA, portable computer or the like, as a conduit to communicate the user's desired (and voluntary) location based service request to the database server. The locator device is not tied to a specific wireless device such as a cell phone and therefore uses its own unique identifier, freeing it from operation with a particular wireless device.

In one embodiment, the locator device emulates a wireless Bluetooth™ headset from the perspective of the wireless device. The locator device communicates DTMF tones over a Bluetooth™ radio link (rather than actual voice communication as would be the case with a headset). This provides a reliable means of communicating information in a format that is essentially universal amongst all wireless devices (cell phones) and avoids the issues inherent in a wireless link that is an audio transmission between the wireless device and the locator device. Bluetooth™ headset communication is important because it is a universal “open” standard—widely available on almost all cell phones. However, any type of communications protocol could be employed provided that it was available on a wide variety of makes and models of wireless devices.

The locator device identifier is generally unique to that locator device and is communicated along with either real time or previously saved positional information to a database server. The locator device can then be a master of the service initiated by the user, independent of a particular wireless device or the operability of the wireless device at a given moment. The disclosure provides for a locator device with a unique device identifier and database selection identifier which can be transmitted along with positional information (either current or previously saved) over a communications network using any of a variety of mobile and/or land line communication devices within range of the locator so that the user obtains specific desired location based information to a predetermined communications device with the push of a button. The user need not key in or verbally communicate a location based service request to an operator facility or database server.

In a preferred embodiment, a locator device for initiating distribution of positional information is disclosed. The device comprises a first toggle and a transmitter. The toggle is for initiating acquiring a geographic position. The transmitter communicates to a wireless device a device identifier associated with the locator device, the geographic position and a command to cause the wireless device to communicate the device identifier and the geographic position to a server. The server selects target information by reference to the geographic position and the device identifier and reports the target information.

The first toggle of the devise generates a database selection communicated to the server by the transmitter and the wireless device. The server selects target information by further reference to the database selection. Further, the geographic position is proximate the locator device and may be determined by a GPS receiver.

The device can also comprise a receiver for receiving the geographic position from a GPS receiver within communications range of the locator device and the receiver can be a data port. The transmitter can communicate with the wireless device by an electromagnetic signal. In a preferred embodiment that signal is a Bluetooth™ signal. The transmitter can emulate a transmitter found in a wireless headset.

In further preferred embodiment at least one of the device identifier, the database selection and the geographic position are audio information transmitted to the wireless device from the locator device. That audio information can be DTMF tones.

In a further embodiment a user profile is determined by the server from the device identifier and the user profile is used for selection of the target information.

The target information can comprise marketing information and that marketing information can comprise real estate information. The target information can also be communicated to a user contact including the email address of the user determined by reference to the device identifier.

In a further embodiment, disclosed herein is a method of collecting and distributing positional information using a locator device. The method includes logging, with the locator device, a geographic position and communicating an identifier and the geographic position to a wireless device. The wireless device is directed to communicate the identifier and the geographic position to a server that causes selection of target information by reference to the geographic position and the device identifier and reports the target information.

The method can further comprise logging a database selection and communicating the database selection to the wireless device. The wireless device is then directed to communicate the database selection to the server. The server can select the target information by further reference to the database selection.

The method considers a geographic position proximate to the locator device that can be determined by reference to a GPS receiver in the locator device or in communication with the locator device.

The geographic information and identifier can be communicated to the wireless device as audio information carried by an electromagnetic signal that can be a Bluetooth™ signal. The audio information can comprise DTMF tones that can be converted to data after being received by the server.

The method can also determine a user profile by reference to the identifier. The server causes selection of the target information by further reference to the user profile.

In a further embodiment, a method of communicating a data set generated by a data collection device to a server through a wireless device is disclosed. The method includes initiating, with the data collection device, a telephone connection between the wireless device and a conversion server. Also, transmission of the data set as audio information from the data collection device to the wireless device by an electromagnetic signal established between the data collection device and the wireless device is completed. The audio information is sent on to the conversion server by the telephone connection.

Finally, the conversion server converts the audio information back into the data set.

The electromagnetic signal can be a Bluetooth™ signal and the audio information can be DTMF tones.

Further, the data collection device can emulates a wireless headset communicating with the wireless device. Further, the data set can comprise positional information that can be a GPS determined location. The data collection device can be capable of determining the GPS determined location. The data collection device can also, by a wireless link between the data collection device and a GPS device, be capable of determining the GPS determined location.

In a further embodiment, a data collection device for logging and communicating a data set to a wireless device for onward communication to a server is disclosed. The data collection device comprises a first toggle for initiating acquiring the data set and a transmitter. The transmitter is to command the wireless device to establish a telephone connection with a conversion server. It is also to communicate the data set as audio information from the data collection device to the wireless device by an electromagnetic signal established between the data collection device and the wireless device, the audio information being sent on to the conversion server by the telephone connection. The data set comprises geographic information associated with a position of the data collection device when the toggle is actuated.

### BRIEF DESCRIPTION OF THE DRAWINGS

FIG. 1 shows a system for determining a user's position and providing that information to a database server.

FIG. 2 shows, as a function of the devices and servers embodying the methods disclosed, flow operation of an embodiment of the system for determining a user's position and providing that information to a database server for the purpose of directing the target data from the database server back to the user.

FIG. 3 shows a flow operation of an embodiment of the system of determining a user's position and providing that information to a database server for the purpose of directing the target data from the database server back to the user.

FIG. 4 shows an embodiment of the stand alone device utilized by a user to voluntarily log and deliver positional information to a database server to provide target information back to the user.

FIG. 5 shows a method of extracting and logging marketing data voluntarily provided to the routing server.

### DETAILED DESCRIPTION OF PREFERRED EMBODIMENT(S)

The present method and apparatus provide a mobile locator device (also called a locator device herein) for collecting positional information based on a location of interest to a user and directing that information to a wireless device to communicate the positional information to a routing server. The routing server transmits the positional information and, in some cases, a user profile, to a database server capable of providing target information based on the positional data.

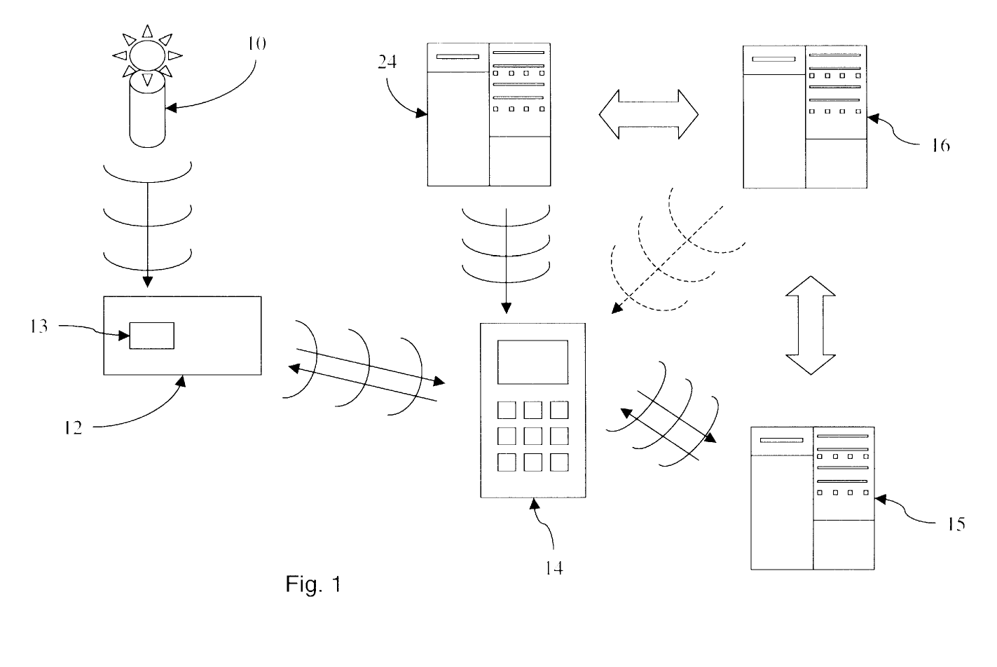

Referring to FIG. 1, in a preferred embodiment, satellite network 10 is used to provide positional information to locator device 12, which is equipped with a global positioning satellite (GPS) receiver internally housed within locator device 12. Locator device 12 also includes toggle 13 and memory [ROM], which stores a unique device identifier associated with locator device 12. Locator device 12 is capable of communication with wireless device 14, which, in turn, is capable of communication with a conversion server 15 for converting received audio information from wireless device 12 into a (usually binary) computer data set. Such data set is directed onward to routing server 16, which manages the transfer of information to database server 24.

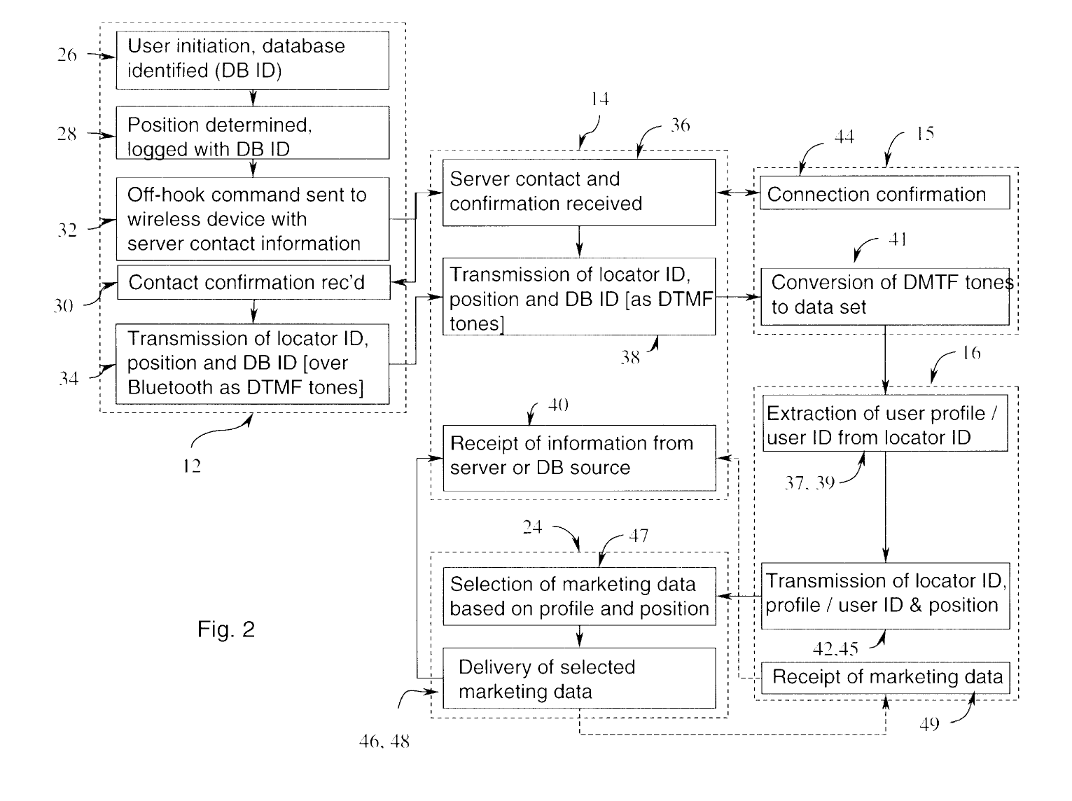

Referring to FIG. 2, a flow diagram of information flow of the preferred embodiment is provided. Here, locator device 12, wireless device 14, conversion server 15, routing server 16 and database server 24 are identified enclosing the general steps of the method disclosed and carried out by each of the main components of the system. Preferred functional steps are provided within locator device 12. These include initiation step 26, positional data determination step 28, wireless initiation step 32, wireless link establishment step 30 and positional information transmission step 34. Likewise, for wireless device 14, the main functional steps performed within this device are also provided. These include conversion server link confirmation step 36, positional information transmission step 38 and optional wireless service request results step 40. In conversion server 15, connection confirmation step 44 and conversion step 41 are provided. Within routing server 16, positional message extraction step 37, user profile extraction step 39, information management step 42, 45 and service request results step 49 are provided. Finally, database server 24, provides selection of marketing data step 47 which is selected based on the positional information and user profile received from routing server 16, and information delivery step 46, 48.

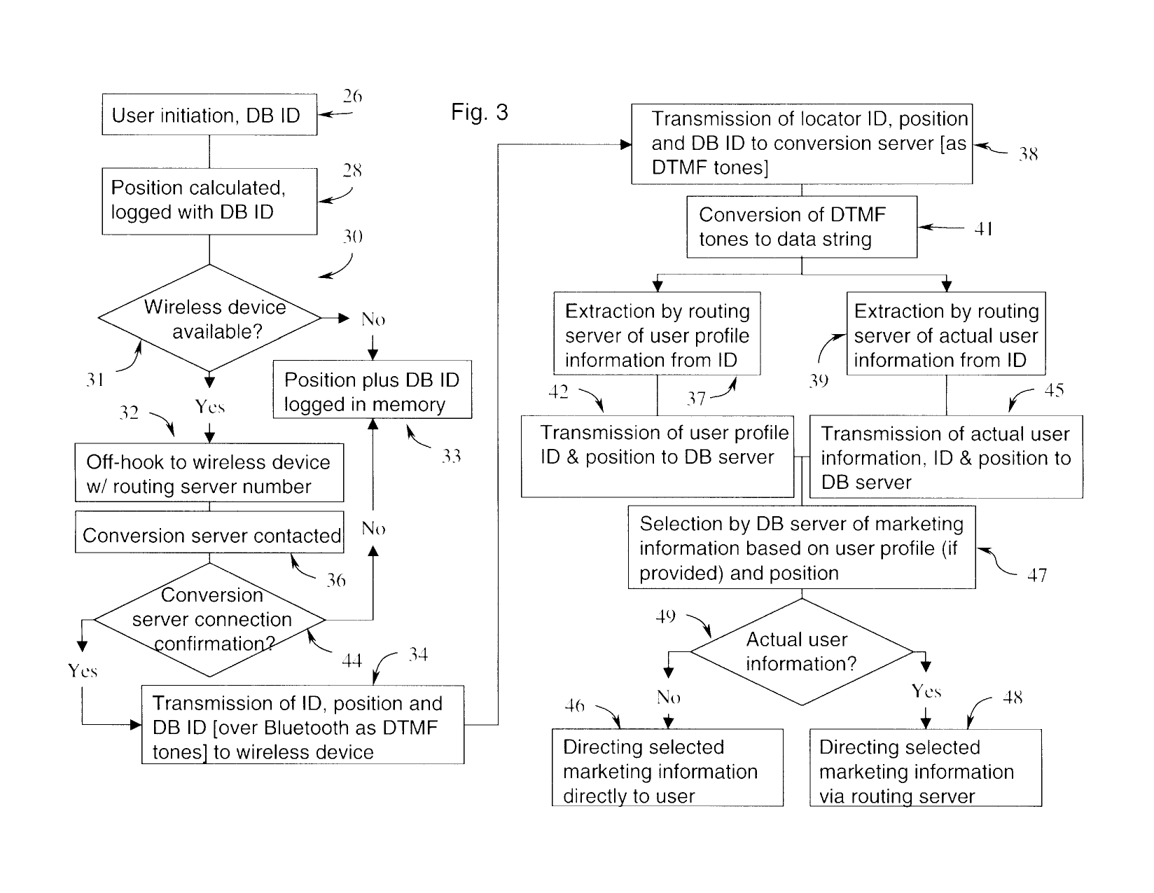

Referring to FIG. 3, the method illustrated in FIG. 2 is further described. Here however, the steps are provided without reference to the “hardware” used to carry out those steps, namely, locator device, wireless device, conversion server, routing server and database server. Many of the same steps found in FIG. 2 are provided for in FIG. 3. However, wireless device proximity step 31 and data log in memory step 33 are further represented.

Locator Device

In general locator device 12 is capable of:
(a) at a user's request,
(b) determining and storing long term or temporarily, positional information associated with the user requests, indicating point of interest to the user proximate to the user's position when making such request,
(c) combining the positional information requested with an identifier associated with locator device 12,
(d) communicating through a wireless communication (preferably public switched telephone network and/or internet), the positional information and the identifier to a database server preferably, but not necessarily, via a DTMF conversion server, for converting the request to a data set, and routing server, designed to manage the data string generated by a request,
(e) doing so in real time while being proximate to the position associated with the positional request.

In general, referring to FIGS. 1 through 3, locator device 12 is useful wherever marketing or other generally requests for target information benefits from an understanding of the geographical position of the user at a given point in time. Moreover, positional information voluntarily provided becomes even more useful than positional information alone as it provides not only positional information about a user but also provides that information with the associated knowledge that a user is interested in receiving target information. By way of example, if the target information is real estate marketing information, a potential buyer can use locator device 12 to log or communicate positional information proximate to real estate of interest. Moreover, the real estate marketing data is already available and includes a searchable parameter that is associated with geographical position. This provides a means of fostering quick adoption of the disclosed locator device 12 where other services would be unlikely to be made available until a volume of the locator devices becomes available. That being said, there are a variety of applications where positional information proximate to a retailer, service provider or marketing opportunity can benefit from combining:
(a) positional information of the user;
(b) a profile of the user (associated with the device);
(c) knowledge that the marketing opportunity of interest to the marketing information provider is being requested voluntarily; and
(d) access to this information moments after a request is made (in real time).

As noted above, an identifier associated with locator device 12 can, in turn, be associated with a profile of a particular user of device 12 and will be generally associated with actual data identifying the user.

Target information sought by a user when actuating locator device 12 generally assumes the provision of marketing information. However, tourism information (for example, information about a particular historical sight) provides an example of information that is not strictly marketing of a particular product or service as would be the case with retail, food services, real estate or others. There, reference to target information includes information that might be sought and selected based on geographical positioning in combination with the user profile.

For the purposes of this application, a profile of the user can include the actual identifying details of the user such as name, address or other unique features, which alone or in combination identify the actual user but will in general be limited to a profile of the user without identifying the actual user. Information such as age, income, general location of residence, interests and other features that might be of interest from a marketing point of view can be included in the profile. By way of example, if real estate is the market of interest, then the profile can include information such as number of children, age of children, price ranges of interest. If retail marketing is of interest, the profile can include clothing sizes, age and/or profession. This would be a profile set up in cooperation with the database provider and the provider of device 12.

Where a locator device 12 is used in real estate marketing, a real estate agent can provide locator device 12 to a user (or potential buyer in this case) and in so doing would record the device identifier associated with the users identification (name and address for example) and perhaps, a profile of the user. The profile can include age, income and/or marital status. Also the user identification could be the device identifier where the identifier is selected from information identifying the user.

While locator device 12 described in the preferred embodiment has a GPS receiver integrated into the locator device 12, it need not be physically in the same device as that used to initiate a request for target information. GPS receivers are available with wireless and wired channels that are capable of providing GPS coordinates to a data port (within a wireless device such as a mobile phone or otherwise) or through other method(s) communicating numbers generally associated with a geographic position, including the wireless communication methods described herein for communication between locator device 12 and wireless device 14. Therefore, locator device 12 is capable of communicating with a stand alone GPS receiving device to secure a GPS derived location and send that information on with a general information request as described herein.

Locator Device—Wireless Device

Once locator device 12 is with the user, he or she would depress (or otherwise actuate) toggle 13 when proximate to a property (or other item or service) of interest to the user. Initiation step 26 occurs when toggle 13 is depressed resulting in positional data determination step 28 where locator device 12 logs, determines or calculates positional information using the GPS receiver in locator device 12 (or in a separate GPS receiver in communication with locator device 12 that is in general proximate to the locator device as the location of locator device 12 corresponds with the location of the user which is the location generally of interest for the target information sought). Wireless device proximity step 31 causes locator device 12 to determine whether wireless device 14 is in communication range with locator device 12. Generally, this would occur when wireless device 14 is proximate to locator device 12. Such communication between locator device 12 and wireless device 14 can be wireless using a link such as Bluetooth™ although other wired and wireless methods of communication can be used such as audio (speaker enabled), ZigBee, WiFi, 802.11 (WLAN), WiMax (802.16), MBWA (802.20), as would be understood by person familiar with the technology involved here. Bluetooth™ is preferred as it provides a reliable mode of wireless communication that is widely available in many commercially available wireless devices. Moreover, as most wireless device users demand wireless headset communication, a Bluetooth™ connection between a wireless headset and wireless device has become widely used for communication. Therefore, use of Bluetooth™ where locator device emulates a headset is an efficient and reliable method of providing locator device 12 remote access to wireless device 14. Here Bluetooth™ can carry a set of DTMF tones to the wireless device, which views locator device 12 as a wireless headset. The wireless device is able to easily communicate these tones to a server as will be described below.

In the event that proximity step 31 results in a conclusion that there is no wireless device in communication with locator device 12, positional information and, if applicable, database selection would be saved in memory on locator device 12 (data log in memory step 33) to be later delivered for information retrieval when a wireless device 14 is in communication with locator device 12 or when locator device 12 is put into communication with an internet, wireless network, telephony network or other network for communicating the positional information and the database selection as provided for below.

Where locator device 12 is in communication with wireless device 14, wireless initiation step 32 causes, in general, an off-hook command to be delivered to wireless device 14. A conversion server contact number is provided to wireless device 14 along with an off-hook command that initiates a call sequence to conversion server 15.

Locator device 12 can, instead of a telephone number, provide a URL or other data node through which information could be sent. As with the above example, a confirmation would be delivered back to locator device 12 from wireless device 14 to indicate that the site was in a mode to accept data.

In general, and as noted above, database selection can be a component of initiation step 26. For example, toggle 13 (which could be a single button but which could typically involve multiple buttons and/or switches or other actuation methods) is depressed in such a way as to provide an indication of the target or marketing information sought by the user. In the real estate application noted above, the database server would be a real estate's server which would in turn, generally, access the multiple listing service (MLS) available to agents. This could include real estate that may or may not be for sale.

In its simplest form, toggle 13 on locator device 12 could be a single depressible button in which a user would depress the button in a certain manner to obtain a desired service. For instance, in the real estate example, if toggle 13 is depressed once, the locator device 12 might send a message request for a real estate search on the current GPS coordinates of locator device 12. If toggle 13 is depressed once and then depressed a second time and held for 3 seconds, locator device 12 might send an email message to the user's real estate agent which would let the agent know the user wished a viewing of the property. If toggle 13 is depressed three times quickly and then held down for 3 seconds, locator device 12 might send an email message and text message alert to the user's real estate agent to let the agent know the user wished to put in an offer for the property.

While toggle 13 has been described in the example above as a single button, it is more beneficial from a database selection capability for toggle 13 to have more than one button or switch for actuation. Where locator device 12 has a number of marketing options, these might be incorporated into toggle 13. In such a case various button combinations associated with toggle 13 would be depressed. For example, Toggle 13 could consist of three (buttons) as follows:

(a) Service Selector Switch

(b) Search Button

(c) Notify Button

If the Service Selector switch was placed on a setting as provided for below, then the following button combinations could generate the following marketing information requests:

| Service | Search | Notify | |
|---|---|---|---|
| Selector | Button | Button | Result |
| Real Estate On | Depress once | — | Requests real estate search |
| Real Estate On | Held down | Depress once | Requests real estate |
| | | | viewing |
| No need to | — | Depress once | Request that user's ID and |
| specify | | | location be sent to specified |
| | | | email recipients |
| No need to | — | Depress | Request that user's ID and |
| specify | | three | location be sent to |
| | | times | emergency 911 provider |

When the service selector switch is in the Real Estate mode, depressing the search button once limits the LBS request to a simple request for real estate information on proximate properties to the user (or saved property locations stored in the memory of locator device 12). When the search button is held down while the notify button is depressed once a request to view a property proximate to the user is communicated by locator device 12 to wireless device 14. Again, in this instance the viewing request would go to the user's agent (the buying agent) that provided locator device 12 in the first place as will be further discussed below.

Additional features can be incorporated that include a distress call which would send out a “911” call providing coordinates of the user when the notify toggle is, in the example provided, depressed three times quickly. A “here I am” feature can also be included to send an email, text message or other communication to a pre-selected location when this service is selected. By way of example, an email could be sent to a spouse indicating the location of the user. Instead of a “here I am” email, the message could also include an instruction to meet at the location indicated by the GPS coordinates. The forgoing example describes the use of multiple buttons to provide locator device 12 with enhanced database selection and service requests. However, persons familiar with the technology involved here would understand how to integrate additional and or alternative indicators such as a LED light in combination with one or more depressible buttons or switches.

The table above is given for purposes of example only and the disclosed system is not limited to such an embodiment. There are a variety of methods of utilizing locator device 12 with the additional feature of database selection included. As noted above, additional services include shopping, food service, refueling station and tourism.

Conversion Server

Conversion server link confirmation step 36 provides to locator device 12 confirmation that the connection to conversion server 15 is established with wireless device 14. Wireless device 14 then receives confirmation of a connection with conversion server 15 in connection confirmation step 44. If the link between conversion server 15 and wireless device 14 is not established, locator device 12 logs the positional data determined from GPS receiver for delivery to conversion server 15 at a later time—data log in memory step 33 is activated as noted above.

Conversion step 41 is where the positional information message transmission is decoded from an initial transmission code. In the preferred embodiment this would be dual-tone multi-frequency (DTMF); however, other encoded formats known to persons familiar with the technology involved here may be suitable. DTMF signaling is used for telephone signaling over telecommunication lines in the voice-frequency band. DTMF encoding/decoding is already available in existing telephony signaling devices, analog or digital, including landline telephones, the common cell phone, and PDAs. Moreover, DTMF is an international telecommunications standard protocol and industry standards require DTMF tones pass over the telecommunications network unimpeded. It is therefore the preferred audio tone signaling used, As most wireless devices are equipped with the capability to receive voice communication through a wireless headset, communication of the positional information, device identification (or identifier), and database selection as a series of DTMF tones is readily available for most wireless devices. Also, as the information provided is essentially a series of digits, use of DTMF tones is an efficient way to communicate the data. For example a request string such as the following demonstrates how quickly information could be communicated and handled by wireless device 14 and servers 15, 16 and 24:
13#6045558934#49*456678#123*38744
where:
first two (2) digit [13] being a database selection;
the next 10 digits [6045558934] being the device identifier;
the next digits [49*456678] being the latitude; and
the next digits [123*38744] being the longitude.

Use of DTMF is preferred as is discussed above, as it provides a ready means of accessing a wireless device without the need to alter the software or hardware of the device.

Preferably, the DTMF tones are carried over a Bluetooth™ connection, which is also readily available in most wireless devices, thereby providing a clean signal from locator device 12 through to wireless device 14 as compared to the wireless audio transmission through a speaker to receiver connection. As such, locator device 12 behaves as a Bluetooth™ headset and, instead of transmitting voice captured by a microphone in a wireless headset, the wireless device transmits DTMF tones carried by the Bluetooth™ connection through to conversion server 15.

While DTMF tones is the preferred method of communicating information from locator device 12, other multiple tone frequency protocol can be used or even other data protocols. However DTMF is a universal standard which is compatible with telephony networks generally, including cellular networks.

In practice, once conversion server link confirmation step 36 provides confirmation that a link has been established between wireless device 14 and conversion server 15 (for example a “0” code back to locator device 12 could signify no connection and a “1” could signify a completed connection), then locator device 12 delivers, in position information transfer step 34, positional information and device identification which is then delivered to conversion server 15 in transmission step 38. As noted above, a database selection option can also be provided in the event that more than one marketing service is available.

Therefore, when conversion server 15 receives a string of DTMF tones corresponding to a series of numbers that represent locator device position and identifier (plus, in some cases other information as noted above), conversion server 15 creates a data string from the DTMF tones and passes that data string onto router server 16 to manage the information—see conversion step 41.

Router Server to Database Server

Once positional data and the locator device identifier is delivered to routing server 16, routing server 16, in the real estate marketing embodiment discussed, extracts from the locator device identifier, either a user profile without detailing the specific information of the user (device identifier conversion step 37) or specific details of the user such as name and address (device identifier conversion step 39) (or both). In the real estate context, as will be discussed below, there is not much benefit secured from isolating a user profile from actual user identification so this information in general is extracted in device identifier conversion step 39.

The user information, whether a profile (information management step 42) or specific information (information management step 45) is then forwarded with positional information to database server 24 to select MLS information (in the real estate example) on the basis of the positional information. The selected MLS information (from pre-determined parameters or selection criteria) is then routed through a separate and independent communications line to either:
(a) routing server 16 in data delivery step 48 to be directed on to the user associated with locator device 12 determined by the device identifier or other identifier that allows a link between the received target information and the requesting user, or,
(b) the user associated with locator device 12 in data delivery step 46.

Such MLS information could be directed by way of a text message or email message to a wireless device associated with the user (in most cases, wireless device 14) or an email account or other location associated with the user. Whether the data is delivered directly to the user via database server 24 or to routing server 16 to be forwarded to the user, is usually dependent on whether or not the routing server 16 is to convert the device identifier to a particular address associated with the user and saved in the user profile. That is, routing server 16 may not provide enough information to database server 24 to allow it to directly provide target information to the user in data delivery step 46.

Generally, delivery step 46 can deliver the selected information directly to one or more addresses associated (and usually selected) by the user (namely, email address, text address, fax number, URL address, pager) if the user profile or user identification included one or more direct addresses for the results. In the event that this is not the case, delivery step 48 delivers the selected information results back to routing server 16 which in turn delivers the selected information directly to the routing address(es) (namely, email address, text address, fax number, pager number) known.

In general, separating routing server 16 and database server 24 provides a feature wherein a marketing or sales organization can maintain control and limit access to marketing data. In many cases, routing server 16 is associated with locator device 12 and would usually not be the same entity as that controlling the data and database server 24. Likewise, the device identifier associated with locator device 12 and the user's details associated with the device can be controlled by location device provider who would also be responsible for routing server 16. In most cases, a user profile (extracted on the basis of the device identifier delivered to router server 16), user position, and the knowledge that the user voluntarily directed such information to a particular marketing service (namely, a database selection which is functionally a request to receive a particular type of marketing data), is valuable information by itself. The data provider associated with database server 24 need not actually know specific details about the user associated with the device. This allows the routing service provider (usually associated with locator device 12) to keep the actual identification and contact information of the user from an entity controlling the database server and, therefore, create loyalty between the provider of the data and the provider of locator device 12 and the associated routing service.

While the above is an important feature of the present method and apparatus, in some contexts it is unnecessary and potentially counterproductive to isolate the data provider from the specific information about a particular user. By way of example, in the real estate context, the data provider—indirectly the real estate agent—benefits from knowing the specific behavior of a user who is an actual target client looking for real estate to better provide the agent the opportunity to secure the benefit associated with understanding that particular users real estate purchasing tendencies. A real estate agent benefits from being a buying agent. Therefore, in this case, the routing server 16 and database server 24 can even be the same server, but in any event, need not be isolated (physically or electronically).

Where a real estate agent provides locator device 12 to a customer (or potential customer), routing server 16 or database server 24 can also direct information regarding a user's request for target information to the agent associated with the user. This gives the agent information about the user's tendencies in a particular real estate market where the agent is in the position to follow-up with the user on a given request for MLS information. This feature helps secure loyalty from a user increasing the likelihood that the agent will be involved, as buying agent, in a sale of real estate of interest to the user. Moreover, locator device 12 can preferentially be fitted with a feature that includes not only a request for real estate information relevant to a particular geographical position but also a request to view the real estate in question. In this case, the agent that provided locator device 12 is alerted with a request to see the real estate associated with the positional information. This creates an easy way for a user to book a viewing time for real estate and, at the same time, avoids a frequent occurrence wherein a listing agent is directly called by a user for a viewing of real estate, thereby cutting out a buying agent. This occurs at present because the listing agents contact details are the most easily accessible as it is usually provided with the “for sale” sign posted on or proximate to a marketed property. However, the relative simplicity and convenience of depressing a toggle for a viewing is likely to provide an even easier way of securing a viewing of a property—through the buying agent who is usually the same agent that provided locator device 12 to the user in the first place. A depression of the toggle is easier than phoning a listing agent and results in the added benefit of additional marketing information associated with the property of interest. Again, this creates increased loyalty between user and agent and a better chance that the buying agent will have an opportunity to be involved in the sale, should one occur.

This feature can be expanded to other marketing contexts where a stakeholder associated with a database of target information, in general, can be alerted regarding the user's shopping or service seeking activities. By way of example, a retailer (usually providing the locator device) can monitor the request made by the user related to a competitor's wares or services or other commercial activity of the user. This can provide a competitive advantage when that stakeholder is marketing his or her wares or considering commercial options for his or her business such as selection of a new retail location, by way of example.

In general, in a real estate context, information transfer step 34 would likely result in a selection from MLS information relevant to the position indicated by the positional information. By way of example, selections from current real estate listings within a one block range of the positional data on a street associated with the position indicated by the positional information might be selected by the database server as an appropriate MLS information selection. Additional information such as recent sales prices and other selected information for sold homes in the same area could also be provided to give a comparison to the listed real estate associated with the positional information voluntarily provided by the user when toggle 13 is depressed.

Communication Links

Referring back to FIG. 1, the communication links established between the components of the system disclosed are provided as indicated with arrows shown. In general wireless links between satellites 10 and locator device 12 are unidirectional where the satellite information is delivered from the satellite to locator device 12. The wireless link between locator device 12 and wireless device 14 is two way over, in general, a single communications line between locator device 12 and wireless device 14. That is steps 30 and 31 are directed from wireless device 14 to locator device 12 and steps 32 and 34 are delivered from locator device 12 to wireless device 14. The wireless link between wireless device 14 and conversion server 15 is also two way where step 36 includes a confirmation of connection indication from server 15 to wireless device 14. Step 38 provides information on the same communication line as step 36 between wireless device 14 and conversion server 15. Finally, wireless communication between router server 16 or database server 24 to wireless device 14 is on an independent line between router server 16 or database server 24, as the case may be, to wireless device 14.

In general, communication between conversion server 15, router server 16 and database server 24 is over the Internet or direct link and is generally not wireless (however, it could be wireless if desired). Also, each of these servers can be remote from each other or proximate to each other depending on the application. In fact, one “server” could conceivably perform all or some of the functions performed by one of conversion server 15, router server 16 and database server 24 as described above. Splitting out the servers based on their functional roles within the systems as a whole illustrates the advantages of the methods and apparatus disclosed, namely, the use of DTMF tones carried over a wireless (for example, Bluetooth™) connection to wireless device 14 and ability to isolate specific user identity from a database server where desirable. However, it is not strictly necessary where a single server can perform a number of the functions described for conversion server 15, routing server 16 and database server 24.

Additional Functionality

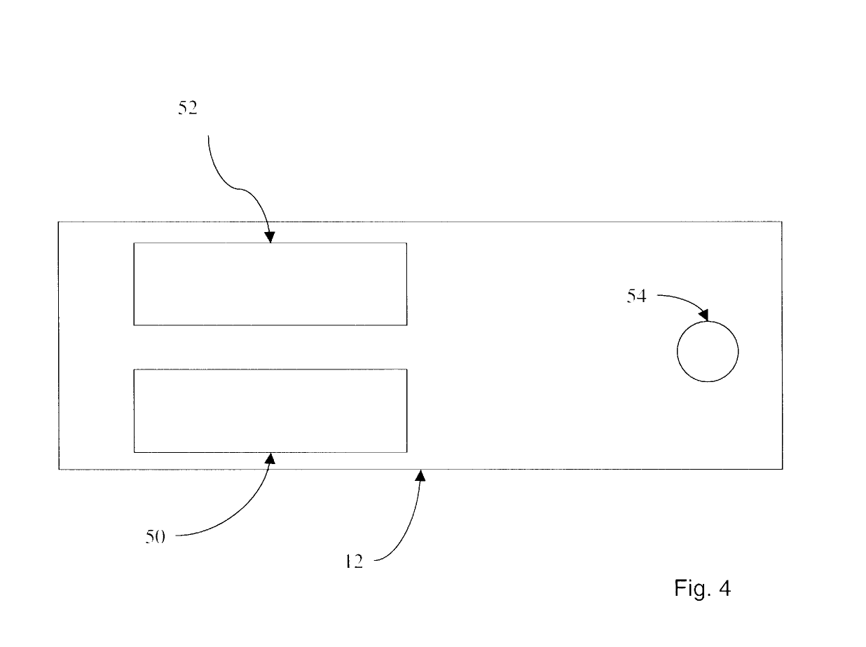

Locator device 12 could also include additional toggles or incorporate depression sequences for the toggle to provide additional capability to locator device 12. FIG. 4 shows locator device 12 with priority toggle 50 and data toggle 52.

Referring to FIG. 4, by way of example, an additional embodiment of toggle 12 would allow database selection for a user, as noted above. Here, by way of example, a user would select between target information for real estate, merchandise, tourism (attractions, historical information) or services such as restaurant, refueling, pharmacy or other services associated with positional information. Priority toggle 50 could be depressed once to indicate priority, namely a request for information versus a request to buy or, in the case of real estate, view. In the example data string provided above this would tend to include an independent digit for priority. Data toggle 52 could be used, by way of example, to select merchandise marketing information, service information or real estate. The number of times the toggles are depressed within a determined time can determine the database selection and priority of interest, by way of example. As well, an emergency help feature could be included where depressing, for example, both data toggle 52 and priority toggle 50 three times within a given time would alert authorities to provide assistance at the indicated position or to call wireless device 14 to confirm an emergency situation.

Referring again to FIG. 4, display 54—LED (or other visual or audio indicator/display)—could be incorporated to help with use of locator device 12. For example display 54 (if an LED indicator) can be on to demonstrate when the device is on and change color for different priority, database selection or indication of wireless device link establishment or proximity (steps 30 and 31).

While GPS is the preferred method of determining positional data, it can also be determined by triangulation methods associated with cell towers, which is understood in the art. However, in general, as the accuracy of this method is less than GPS derived position determination, GPS positioning is preferred.

Marketing Data Logging

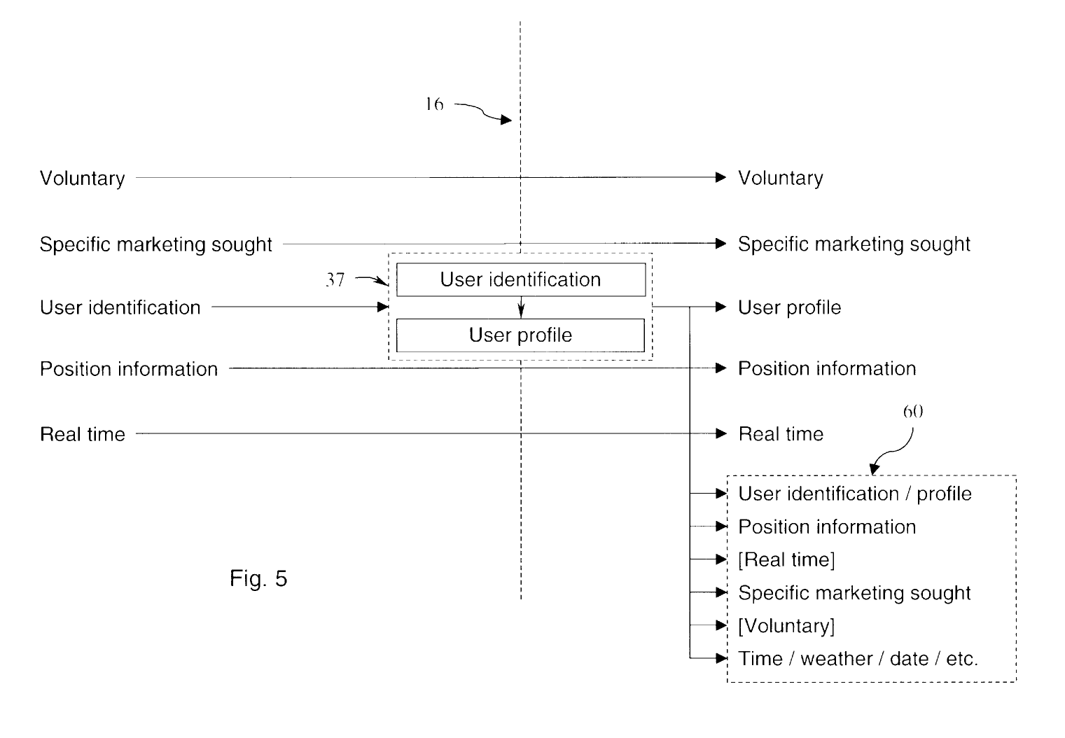

Referring to FIG. 5, router server 16 is shown. Here basic information delivered to router server 16 is, in some cases, filtered through device identifier conversion step 37 before being passed to database server 24. As router server 16 is in the unique position of collecting data from potentially a vast network of locator devices, associated with a variety of users, in a variety of locations, seeking a variety of marketing services, a method is provided of accumulating that data in a market logging step 60. As has been noted above, locator device 12 is capable of providing the following information:
(a) collection of voluntarily sought market information;
(b) associated with a geographic location;
(c) in real time;
(d) for a variety of marketing services (retail, service, tourism, real estate or other marketing services);
(e) a user profile plus the actual user identification;
(f) other data associated with the time of a request and/or geographic location (time, weather, date)), which can be determined by additional functionality in the locator device or determined by the routing server with access to service to provide such information).

Individually such information is nothing more than a snapshot of a particular consumer's behavior; however, the total information flowing to router server 16 from many locator devices can provide a profile of consumer trends and marketing intelligence. By way of example, trends in the interest in a particular area for real estate purposes can be identified or trends in the desirability of a new shopping area can be determined. This can create a marketing profile based on the requested target information. Collecting this information in a separate market logging step 60 is a unique function available to router server 16, where database server 24 may only discern the behavior of a particular user profile for the marketing service sought rather than an overall profile of trends in market behavior tied to geographical movement and the associated voluntarily sought information.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A locator device for initiating distribution of positional information, said device comprising:
(a) a first toggle for initiating acquiring a geographic position;
(b) a transmitter, to communicate to a wireless device:
(i) a device identifier associated with said locator device;
(ii) said geographic position; and;
(iii) a command to communicate said device identifier and said geographic position to a server;
wherein said server selects target information by reference to said geographic position and said device identifier and reports said target information.

2. The device of claim 1 wherein said first toggle generates a database selection communicated to said server by said transmitter and said wireless device, said server selecting said target information by further reference to said database selection.

3. The device of claim 2 wherein said geographic position is proximate said locator device.

4. The device of claim 3 further comprising a GPS receiver for determining said geographic position.

5. The device of claim 3 further comprising a receiver for receiving said geographic position from a GPS receiver within communications range of said locator device.

6. The device of claim 5 wherein said receiver is a data port.

7. The device of claim 3 wherein said transmitter communicates with said wireless device by an electromagnetic signal.

8. The device of claim 7 wherein said electromagnetic signal comprises a Bluetooth™ signal.

9. The device of claim 3 wherein said transmitter emulates a transmitter found in a wireless headset.

10. The device of claim 7 wherein at least one of said device identifier, said database selection and said geographic position are audio information.

11. The device of claim 10 wherein said audio information comprises DTMF tones.

12. The device of claim 3 wherein a user profile is determined by said server from said device identifier, said user profile used for selection of said target information.

13. The device of claim 3 wherein said target information is marketing information.

14. The device of claim 13 wherein said marketing information is real estate information.

15. The device of claim 3 wherein said database selection corresponds to real estate information.

16. The device of claim 15 wherein said real estate information is selected from MLS data.

17. The device of claim 3 wherein said target information is reported to a user contact determined by reference to said device identifier.

18. The device of claim 17 wherein said user contact is an email address.

19. A method of collecting and distributing positional information using a locator device, said method comprising:
(a) logging, with said locator device, a geographic position;
(b) communicating an identifier and said geographic position to a wireless device;
(c) directing said wireless device to communicate said identifier and said geographic position to a server;
wherein said server causes:
selection of target information by reference to said geographic position and said device identifier, and
reporting of said target information.

20. The method of claim 19 further comprising logging a database selection, communicating said database selection to said wireless device, directing said wireless device to communicate said database selection to said server wherein said server causes selection of said target information by further reference to said database selection.

21. The method of claim 20 wherein said geographic position is proximate to said locator device.

22. The method of claim 21 further comprising determining a user profile by reference to said identifier, wherein said server causes selection of said target information by further reference to said user profile.

23. The method of claim 21 wherein said locator device determines said geographic position from a GPS receiver in said locator device.

24. The method of claim 21 wherein said locator device logs said geographic position from a GPS receiver in communication with said locator device.

25. The method of claim 21 wherein said device identifier, said geographic position and said database selection are communicated to said wireless device as audio information by an electromagnetic signal.

26. The method of claim 25 wherein electromagnetic signal comprises a Bluetooth signal.

27. The method of claim 25 wherein said audio information comprises DTMF tones.

28. The method of claim 25 further comprising converting said audio information to data after said audio information is received by said server.

29. The method of claim 19 wherein said target information is real estate information.

30. The method of claim 29 wherein said real estate information is selected from MLS data.

31. A method of communicating a data set generated by a data collection device to a server through a wireless device, said method comprising:
(a) initiating, with said data collection device, a telephone connection between said wireless device and a conversion server;
(b) transmitting said data set as audio information from said data collection device to said wireless device by an electromagnetic signal established between said data collection device and said wireless device, said audio information being sent on to said conversion server by said telephone connection;
(c) converting, with said conversion server, said audio information back into said data set.

32. The method of claim 31 wherein said electromagnetic signal comprises a Bluetooth™ signal.

33. The method of claim 31 wherein said audio information comprises DTMF tones.

34. The method of claim 31 wherein said data collection device emulates a wireless headset communicating with said wireless device.

35. The method of claim 31 wherein said data set comprises positional information.

36. The method of claim 35 wherein said positional information is a GPS determined location.

37. The method of claim 36 wherein said data collection device is capable of determining said GPS determined location.

38. The method of claim 36 wherein said data collection device receives said GPS determined location by a wireless link between said data collection device and a GPS device capable of determining said GPS determined location.

39. A data collection device for logging and communicating a data set to a wireless device for onward communication to a conversion server, said data collection device comprising:
(a) a first toggle for initiating acquiring said data set;
(b) a transmitter for:
(i) commanding said wireless device to establish a telephone connection with said conversion server, and,
(ii) communicating said data set as audio information from said data collection device to said wireless device by an electromagnetic signal established between said data collection device and said wireless device, said audio information being sent on to said conversion server by said telephone connection,
wherein said data set comprises geographic information associated with a position of said data collection device when said toggle is actuated.
